(19) United States
(12) Patent Application Publication
(10) Pub. No.: US 2020/0410600 A1
(43) Pub. Date: Dec. 31, 2020

(54) AUTOMATION AND ROBOTIC INSURANCE POLICY

(71) Applicant: Juan Carlos Guillen, Rochelle Park, NJ (US)

(72) Inventor: Juan Carlos Guillen, Rochelle Park, NJ (US)

(21) Appl. No.: 16/720,031

(22) Filed: Dec. 19, 2019

Related U.S. Application Data
(60) Provisional application No. 62/782,053, filed on Dec. 19, 2018.

(51) Int. Cl. G06Q 40/08; G06Q 40/02; G06Q 30/00; G06Q 50/26; G06Q 50/20; G06Q 10/10; G06F 21/64; G09B 19/00; G01S 19/51

(52) U.S. Cl. CPC G06Q 40/08; G06Q 40/02; G06Q 30/0185; G06Q 50/265; G01S 19/51; G06Q 10/1053; G06F 21/64; G09B 19/00; G06Q 50/2057

(57) ABSTRACT

The computer implemented system and method for providing insurance policy to an individuals whose job is or may be lost due to displacement by an artificial intelligence, automation and/or robotics is disclosed. The system and method offers insurance policies to individuals or an organizations and allows to access and register within the system using a user interface device. The computer implemented system then verifies, reviews and identifies the risk factors related to the individual and accordingly defines and offers the insurance plans to the applicant for providing coverage in case of job displacement due to artificial intelligence, algorithms, augmented reality, automation, software, machine learning, technology and virtual reality or any other advancement in technology. Further, the computer implemented system comprises and provides services such as educational service for improvement of skill of individual, service for development of recruitment strategies within the individual, services of connecting the individual with staffing agencies for new job.

### CROSS-REFERENCE TO RELATED APPLICATION

This application claims the benefit of U.S. Provisional Application No. 62/782,053, filed Dec. 19, 2018, entitled “Automation and Robotic Insurance Policy”

### FIELD OF THE INVENTION

The present invention is directed to a computer implemented method and a computerized system for providing variable insurance policies. More particularly, the present invention relates to computer implemented method and system for offering, defining and providing insurance coverage, services and assistance to an individuals who has been displaced by advancement in technology.

### BACKGROUND OF THE INVENTION

The advance of technology has provided newer and more advance machines that are capable of performing jobs that were previously performed only by human employees. The complete list of such jobs expands regularly and has grown to encompass both “skilled” and “unskilled” positions. One well-known example of such a job exists in the automotive industry, where assembly line workers are regularly displaced due to robotic machines designed to perform precise and repetitive tasks. More recently, some giant e-commerce companies have implemented robotics in their inventory management positions and self-checkout systems, respectively. Even jobs requiring some degree of judgment are at risk of being overtaken by robots currently in development. Cars are being designed that can drive themselves, and artificially intelligent robots are being developed to displace physicians and surgeons during patient interactions.

With the rise of technology and automation, many people are questioning “Where will my job be in the future?”. Automating jobs is not a local or state issue, it is now a national issue and it's gone as high up to even the Presidency. 2020 Presidential Candidate Andrew Yang. Andrew Yang believes “automation and advanced A.I. will soon make millions of jobs obsolete—yours, mine, those of our accountants, radiologists and grocery store cashier” “All you need is self-driving cars to destabilize society.” His campaign message: “The robots are coming.” Recent reports by BBC have indicated “Automation, Robots Will Replace 800 Million Jobs Worldwide by 2030”. Studies suggest anywhere from 9 percent to 47 percent of American jobs could be automated in the next few decades and Politicians have even proposed a “robot tax” to combat the rise of automation.

Insurance policies are already available to protect an insured against the loss of employment and income, though such policies may limit recovery to specific causes such as injury or job relocation. Many states also provide unemployment insurance to employees which may be applied regardless of cause, though such insurance may not provide adequate compensation to the insured and may not be customizable to the insured's unique needs. No insurance exists, though, to specifically protect an insured from loss of employment and income as a result of being displaced by artificial intelligence, automation and/or robotics.

Therefore, there is a need of a computer implemented method and system in the art for an insurance policy providing coverage to an individual against job losses due to advancement in technologies such as artificial intelligence, automation and/or robotics. Such an insurance may provide an insured with adequate compensation not otherwise provided by state unemployment benefits or other forms of unemployment insurance. Further, there is a need to provide people with economic security and a second opportunity to advance their careers by encouraging people to utilize the funds to either go back to school, enroll in re-training programs, or even start a business, if they loses their jobs to the technology such as artificial intelligence, automation and/or robotics.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

According to one embodiment, the subject matter of present invention discloses a computer implemented method and a system to suggest and provide insurance policies, services and assistance to the individuals who has or may lose their job due to advancement in technology such as, introduction of advance alternatives like Artificial Intelligence, algorithms, augmented reality, automation, software, machine learning, technology and virtual reality etc. that may replace the individual, making him/her jobless. The computer implemented system and method for insurance plan or policy of present invention; allows offering of an insurance plans to an individual who has lost their job or who may lose due to Artificial intelligence or Automation or Robotics or due to any technical advancement; allows electronically documentation and claiming of insurance coverage by the individual using any user interface device; electronically investigates and allows verification of the cause of job loss using the user interface device; electronically approves the insurance coverage, if the claim by the individual is valid and honest; and electronically provides the coverage to the individual based on the variable policies and contract with an individual.

According to an embodiment of present invention, the computer implemented system and method allows individual employee or a group of employees at a partner corporation to select an insurance policy, where the group insurance policies comprises collective bargaining assistance on behalf of the group of employees. Further, all the insurance policies, plans and other financial products of present computer implemented system and method includes, educational assistance including courses and tuition for new skill development, recruitment strategies such as job seeking and job training assistance along with the variable compensation which is calculated based on insured's eligibility and risk factor.

According to one embodiment of present invention, the computer implemented system and method for providing variable insurance policies and plans against job loss due to artificial intelligence, automation or robotics, where the system allows individual employees, group of employees or an employer of an organization to establish an employer sponsored or percentage of employee salary sponsored Automation Job Displacement Savings Accounts (AJDISA) for all the employees of the organization, that allows the employers or individual employees to electronically make the payment of premium using the user interface of the system, according to the variable insurance plan. The Automation Job Displacement Savings Accounts (AJDISA) may be fully funded by the employer or partly funded by the employer and partly by the percentage of wages of the employees. Also, the Automation Job Displacement Savings Accounts (AJDISA) allows to receive compensation of insurance claims that may be dispersed weekly, bi-weekly or monthly basis over 1 to 5 years or may be paid in one lump-sum into the Automation Job Displacement Savings Accounts (AJDISA) of the insured, according to variable insurance policies of present system. According to one embodiment, if the individual's job is never displaced by the advancement in technology, the individual may roll the savings into a retirement account.

According to one embodiment, the computer implemented system and method for providing variable insurance policies and plans against job loss due to artificial intelligence, automation or robotics; where the logic machine or algorithm stored within the processor of the system creates a variable insurance policies and defines the product/policy features for the purpose of providing insurance coverage to individuals against job loss due to artificial intelligence, automation or robotics. The policy or product features includes identifying the duration of contract, benefit (whether a fixed amount or indemnification), options of premium payment (i.e. monthly, quarterly, half-yearly and yearly), high level exclusions, etc.

According to one embodiment, the logic machine or an algorithm within the processor of the computer implemented system further defines the underwriting strategy which includes identification of the type of risks to cover and required rates for it. For example, some risks are standard risks and standard rates can apply. For some, which are riskier, a higher rate should be charged and in some cases, the system automatically denies to provide an insurance policy.

According to one embodiment, before the system creates a variable insurance policies and defines the product/policy features for the purpose of providing insurance coverage to individuals against job losses due to artificial intelligence, automation or robotics; the logic machine or an algorithm within the processor of the computer implemented system: Identifies risk factors that includes factors which impact the propensity to claim including but not limited to the nature of job, the type of industry etc.; Identifies rating factors that includes factors on which the premiums would be based which should be same as the risk factor ideally, but it relies on proxies of the risk factors in most cases; Identifies risk premium related assumption factor for creating probability and weights for each of the rating factors, where the risk premium related assumption factors includes research and determination of the assumptions/incidence rates available in the public domain for the local markets of the respective countries; Identifies the expense related assumptions such as expenses towards infrastructure (i.e. office space), salaries of the employees and commissions, apart from the cost of claims; Identifies retention assumption which helps in creating a price model based on term/duration of contract; and identifies remaining assumptions that includes profitability criterion, inflation rate, interest rate, risk discount rate and margins for adverse deviation.

According to one embodiment, before system creates a variable insurance policies and defines the product/policy features for the purpose of providing insurance coverage to individuals against job losses due to artificial intelligence, automation or robotics; the logic machine or an algorithm within the processor of the computer implemented system further: creates an actuarial and parameterized model of the individual; creates competition analysis by comparing rates with existing competitors; performs sensitivity testing by identifying how the profitability must be impacted if the assumptions turn out to be different in reality which allows the system to calculate the extra money to be set aside for paying the claims; and documentation of model and assumptions which ensures that the model can be re-used by any new user without little or no help and also the rationale for assumptions used and limitations need to be documented.

According to one embodiment, the computer implemented system for issuing insurance policy for the purpose of providing insurance coverage to individuals against job loss due to artificial intelligence, automation or robotics comprising; a processor having a logic machine; a memory unit or a storage machine coupled to the processor that stores an algorithms and a computer programs executable by the processor to receive an applicant data relative to a prospective applicant for job displacement insurance policy, to apply one or more business rules for the automation job displacement insurance policy stored in the memory to the applicant data to determine whether said prospective applicant qualifies for the automation job displacement insurance policy, and to transmit the automation job displacement insurance policy to a policyholder. The policy holder is comprised of the prospective applicant determined to qualify for the job displacement insurance policy. The job displacement insurance policy provides a coverage and benefit in the form of one or more payments to a policy holder as the result of said policy holder experiencing job losses due to artificial intelligence, automation or robotics.

According to one embodiment, the computer implemented system for issuing insurance policy for the purpose of providing insurance coverage to individuals against job losses due to artificial intelligence, automation or robotics comprising; a processor having a logic machine; a memory unit or a storage machine coupled to the processor that stores an algorithms and computer programs which are executable by the processor; to receive a job displacement insurance policy claim from a policyholder of a automation job displacement insurance policy, to determine the eligibility of the policyholder for one or more coverage and benefits of said policy, to calculate the coverage and benefit amount to be paid to said policyholder based upon said eligibility determination, and to authorize payment of said coverage and benefit to said policyholder.

According to one embodiment, the computer implemented method for issuing insurance policy for the for the purpose of providing insurance coverage to individuals against job losses due to artificial intelligence, automation or robotics comprising the steps of: electronically offering financial products and services to the employers of organization, group of employees or an individual employees; allowing the perspective applicant such as employers, group of employees or an individual employees to register within the computer implemented system using respective user interface; receiving applicant data of geolocations, demographics, government studies related to a prospective applicant from the user interface of the perspective applicant; evaluating risk factor by the logic machine and processor of the computer implemented system using statistical analysis of applicant data; and electronically underwriting insure based on risk assessment; and electronically issuing the job displacement policy to the prospective applicant.

According to one embodiment, the computer implemented method for issuing insurance policy for the purpose of providing insurance coverage to individuals against job losses due to artificial intelligence, automation or robotics further comprising the steps of: allowing insure/applicant to electronically claim the insurance using the user interface, in case of job loss due to advancement in technology such as due to automation or AI or Robots; electronically reviewing, documenting and processing the insurance claim by the processor and logic machine of the computer implemented system; electronically investigating the insurance claim by the computer implemented system; electronically verification by the computer implemented system as well as manually verification by the individuals of the system about the cause of job loss and insurance coverage claim; Electronically approving the insurance claim; and developing payment methods and system for the purpose of providing insurance coverage to individuals against hob losses.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 schematically presents an overview of an insurance policy for the purpose of providing insurance coverage to an individual whose job may be lost due to displacement by artificial intelligence, automation and/or robotics.

FIG. 2 schematically presents a computing system with all the electronically coupled sub-systems of the present computer implemented system for providing insurance coverage to an individual whose job may be lost due to displacement by artificial intelligence, automation and/or robotics.

FIG. 3 illustrates financial services offered to an individual who may be displaced due to artificial intelligence, automation and/or robotics. The process of underwriting and determining insurance premiums based on statistics provided by local and federal government and private companies.

FIG. 4 schematically illustrates a method and process of insurance coverage and benefit claiming.

FIG. 5 schematically illustrates the method and process of verification of job displacement due to artificial intelligence, automation or robotics.

FIG. 6 schematically illustrates the process by the system and method of providing insurance coverage and additional benefits after approval of claim of claimant.

FIG. 7 schematically illustrates the method of development, offering and providing insurance policy to the individuals by the computer implemented system of present invention.

### DETAILED DESCRIPTION OF THE INVENTION

The embodiment herein and the various features and advantageous details thereof are explained more fully with reference to the non-limiting embodiments and detailed in the following description. Descriptions of well-known components and processing techniques are omitted so as to not unnecessarily obscure the embodiments herein. The examples used herein are intended merely to facilitate an understanding of ways in which the method and embodiments herein may be practiced and to further enable those of skill in the art to practice the embodiments herein. Accordingly, the examples should not be construed as limiting the scope of the embodiments herein.

The computer implemented system and method to suggest and provide variable insurance policies, services and assistance to the individuals who has or who may lose their jobs due to advancement of technology such as introduction of advance alternative like Artificial Intelligence, algorithms, augmented reality, automation, software, machine learning, technology and virtual reality etc. that may replace the individual making him/her jobless is disclosed. The computer implemented system and method of variable insurance policies for individuals displaced job due to advancement in technology, where the computer implemented system electronically approaches and suggests the insurance policies to the individuals and organizations of type of industries where there are chances of displacement of employees due to advancement of technology.

The computer implemented system of present invention, from the statistics provided by local and federal government and private companies, evaluates the individuals and organization where there is probability of job loss due to advancement in technology such as introduction of Artificial Intelligence, Automation, Robotics or any other technology that may replace the individuals from their respective jobs. The computer implemented system and method of variable insurance policies of present invention electronically approaches and suggests the individuals, group of employees of single organizations or an employers of an organizations about the variable insurance policies for individuals who may be displaced by the Artificial Intelligence, Automation, Robotics or any other advancement in technology. The computer implemented system of present invention allows registration and purchasing of an insurance plans and policies of present invention by accessing the computer implemented system of present invention using the user interface and by submitting required documentation, personal or employer organization details, job history, actuarial and parameterized details etc. The computer implemented system and method of present invention, based on the documentation and details of the applicant/individual, electronically identifies risk factors, identifies rating factors, identifies risk premium related assumption factors, identifies expense related assumptions, identifies retention assumptions and competition analysis and accordingly defines product features of the plans of the variable insurance policy for the individual. The computer implemented system and method of variable insurance policies comprises of a collective bargaining assistance on behalf of group of employees or employer of organization for allowing bargaining within the insurance plan defined and offered by the computer implemented system.

According to one embodiment, the computer implemented system and method of variable insurance policies of present invention for individuals displaced due to advancement in technology, where the system establishes Automation Job Displacement Insurance Savings Account (AJDISA) of individuals purchasing defined insurance policy by the system. These saving accounts may be funded by a percentage of wages contributed by the employee or employer till duration of the contract defined in the insurance policy or plan.

According to one embodiment, the computer implemented system and method for variable insurance policies of present invention allows user to electronically claim the benefit and coverage of the plan using the user interface, when displaced by the advancement in technology or when losses their jobs to the artificial intelligence, automation, robotics etc. The system and method of present invention electronically authenticates and thoroughly verifies the reason of job loss of the ensure using different electronic and manual methods before dispersing the coverage to the ensured. The system of present invention may electronically disperse the amount weekly, bi-weekly, monthly or may be paid in one lump-sum amount into the Automation Job Displacement Insurance Savings Account (AJDISA) of the insured. According to one embodiment, all the plans and offers of the variable insurance policies of the present invention comprise of educational assistance including courses and tuition, recruitment strategies such as job seeking and job training assistance along with the insurance coverage money.

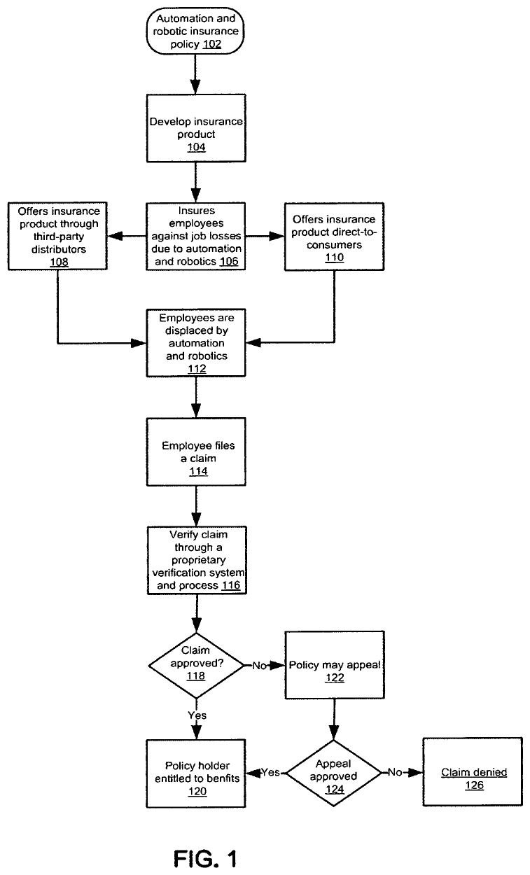

Now, referring to FIG. 1 which schematically presents an overview of a computer implemented insurance policy for the purpose of providing insurance coverage to an individual whose job may be lost due to displacement by artificial intelligence, automation and/or robotics. The computer implemented insurance policy of present invention may be sold either to individual employees or as part of a partnership agreement with certain corporations. The purpose of such insurance is to provide employees with a source of income even after loss of employment specifically caused as a result of displacement by artificial intelligence, automation and/or robotics. Once terminated, the employees may be provided with weekly compensation benefits or a one-time severance payment. The insurance policy may further provide an insured with job-displacement assistance and may comprise an employees' union to advocate on behalf of such employees.

FIG. 1 exemplarily discloses a schematic of a computer implemented system of insurance policy for individuals who may lose their jobs to advancement in technology. The schematic discloses computer implemented automation and robotic insurance policy 102 that is variable, where the system prepares or develops the various variable insurance policies and other financial products 104 that insures the individuals or group of employees of organization against job losses due to advancement in technology 106, the insurance plans and policies are negotiable in nature and that is offered to the corporations and businesses having more than 50 employees or that is being offered to an individual 106 requires an insurance policy due to displacement by advancement in technology. The computer implemented system and method for insurance policy of present invention offers insurance product through third party distributors 108 or offers directly to the customers 110. The system of present invention allows ensured to file a claim 112 & 114 of coverage and benefit in case of displacement of job by the automation, AI or robotics. The claim may be filed after a verification letter by a head of human resources (HR) has been registered and/or the claim may be filed after a verification letter by local unemployment services has been registered. Such verification letters may include pictures, witnesses, and/or unique artificial intelligence, automation and/or robotics identification numbers. After verification, if the claim gets approval 118, the computer implemented system of present invention processes the claim and based on the plan/policy, and the claimant may receive weekly benefits, severance pay, and/or donations and other benefits of insurance product 120. In another case, if the system of present invention denies the claim of insured, the system allows ensured/individual to appeal 122 and if the appeal gets approved 124 then the ensured gets the benefits 120 else the claim gets denied again 126. Moreover, all the policies and plans of present computer implemented system for insurance policies comprises partnership with staffing agencies 118 to help claimant get the new job. Further, the computer implemented system of present invention comprises partnership with skill development institutes to add new and trending skill sets into the individual so that he/she may easily get a new job.

In one case, an electronic system is included, in which, a database is created to identify and track job identification numbers (ID), employee identification number (ID) and job descriptions which have been subject to job displacement due to artificial intelligence, automation and/or robotics. The electronic system will review current and previous job identification numbers (ID) and job description. The system will allow employers to indicate if an employee has been displaced by inputting specific related information regarding the employee's job identification number (ID) and descriptions. Such information includes, but is not limited to, the name, manufacturer, tax ID, barcode, serial number, model number, identification number, contracts, videos, or pictures of automation, artificial intelligence, computers, robotics, software, or technology. In one another example, the name, manufacturer, tax ID, barcode, serial number, model number, identification number, contracts, videos, or pictures of artificial intelligence, automation and/or robotics may be used to identify and verify job displacement.

In addition to unemployment compensation, such an insured may further receive such unemployment benefits as job-seeking assistance and job-retraining as a component of their benefits under such an insurance policy. Further additional benefits may come from various donation sources. The computer implemented insurance system may partner with staffing agencies and other appropriate job-assistance agencies to provide such additional benefits.

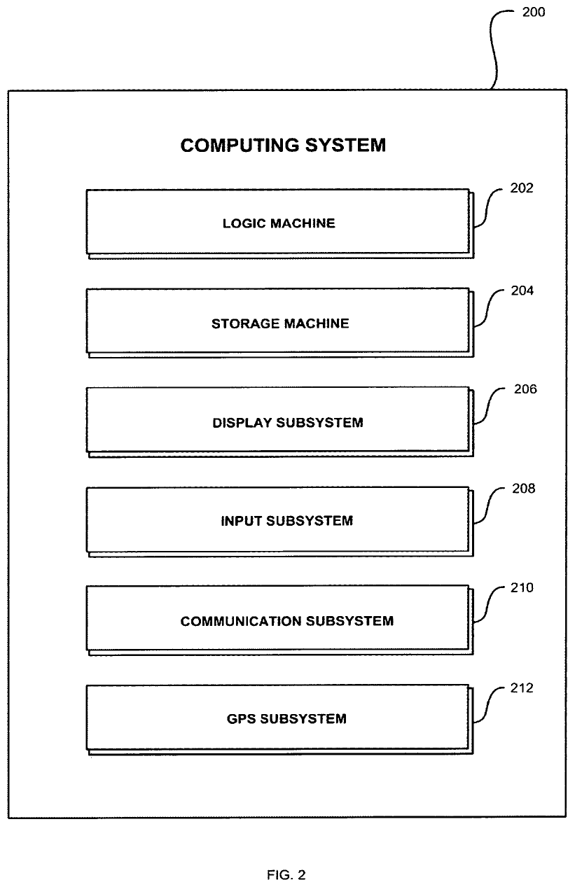

Referring to FIG. 2 now, which schematically presents a computing system 200 with all the electronically coupled sub-systems of the present computer implemented system for providing insurance coverage to an individual whose job may be lost due to displacement by artificial intelligence, automation and/or robotics. The computing system 200 of present invention comprises of a processor with a logic machine 202 that is communicatively coupled with the storage machine 204 to store an algorithms and a computer programs executable by the logic machine 202. The logic machine 202 receives an applicant data relative to a prospective applicant for job displacement insurance policy, applies one or more business rules for the automation job displacement insurance policy stored in the storage machine 204 to the applicant data to determine whether said prospective applicant qualifies for the automation job displacement insurance policy, and transmits the automation job displacement insurance policy to a policyholder. The computing system 200 of present invention further includes a display subsystem 206 to display graphical user interface (GUI) or any visual element of the method and system; and an input subsystem (User Interface) 208 that allows individuals to access the computer implemented system, register or purchase the policies of the system, claim the insurance coverage from the system and also receive benefits of insurance coverage. Moreover, the computing system includes a communication subsystem that allows communication between the individuals wishing to purchase the insurance policy and the employees of computer implemented system of insurance policies of present invention. A GPS subsystem 212 is included within the system that allows determination of geo-location of the individuals wishing for insurance. The described methods or processes may be executed, provided, or implemented for a user or one or more computing devices via a computer-program product such as via an application programming interface (API).

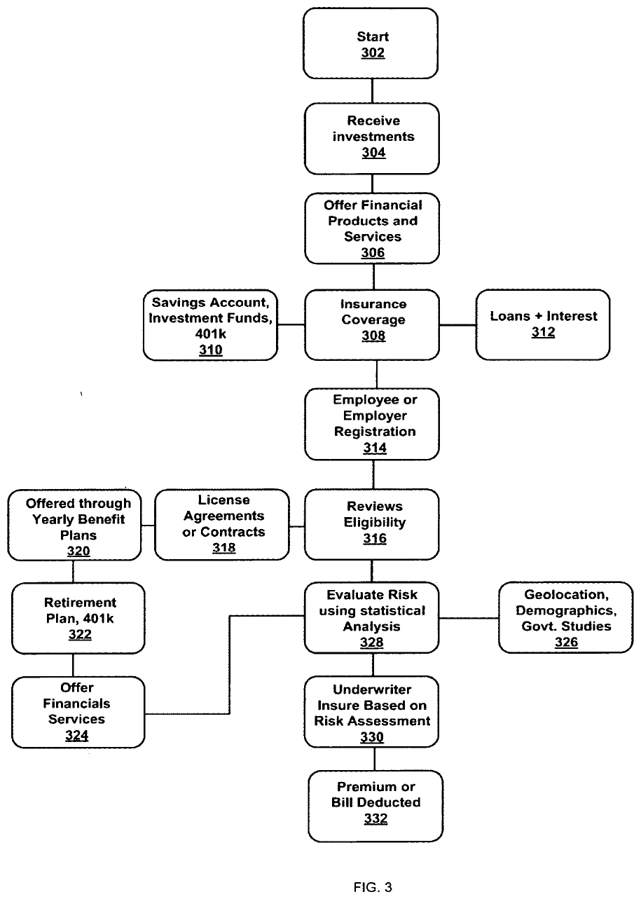

FIG. 3 illustrates flow diagram of method of financial services offered to an individual who may be displaced due to artificial intelligence, automation and/or robotics. The process of underwriting and determining insurance premiums based on statistics provided by local and federal government and private companies. The computer implemented system and method of present invention receives an investment 304 and offers financial products and services 306 to the individuals or organizations having big number of employees, offering financial products such as insurance coverage 308, saving accounts/investment funds/401k (310), loans and interests 312 to the individual who is or who may lost his job due to automation, artificial intelligence, robotics or any advancement in technology. The computer implemented system and method of present invention allows registration 314 by the individual employees or employers into the present system using a user interface. The computer implemented system reviews eligibility of registrant 316 for license agreements and contracts 318, yearly benefit plans 320, retirement or 401k plan 322 or any other financial services 324. The system and method of present invention further identifies geo-location of the user interfaces, demographics of registrant and government studies or federal data about the registrant 326 and accordingly electronically conducts a statistical analysis and evaluates the risk factors and other factors 328 in providing any of the financial service to the respective registrant. After step of evaluation of risk factor 328, the computer implemented system of present invention underwrites insure based on risk assessment 330, successfully provides the financial product to the registrant and according to the insurance plan, deducts the bill or premium from the saving account of the insured/registrant.

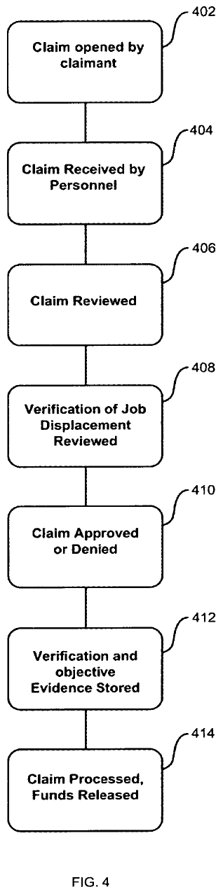

Referring to FIG. 4 which schematically illustrates a method and process of insurance coverage and benefit claiming by the ensured. The computer implemented system and method of insurance policy for displaced by the advancement in technology of present invention allows ensured/claimant to electronically claim benefits and coverage of insurance using the user interface 402 which is received by the processor and logic machine of the system 404. The computer implemented system reviews the claim of claimant 406; electronically and manually verifies the job displacement and reason for the job displacement 408 and accordingly approves or denies the claim of claimant 410. The computer implemented system then stores verified or objective evidence 412 into the storage machine of the system and electronically processes claim of the claimant and disburses funds or benefits 414 based on the insurance plan of claimant.

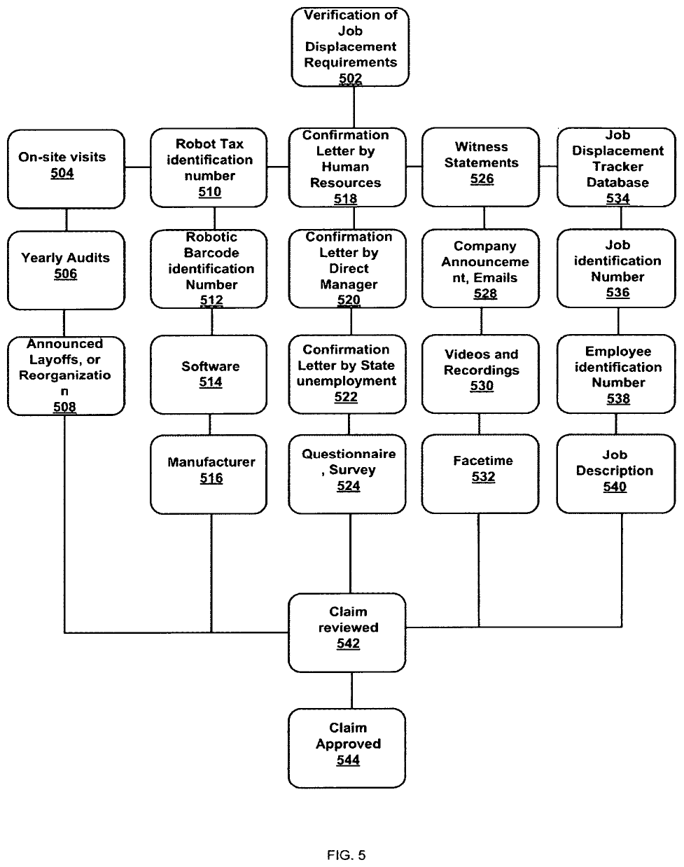

FIG. 5 schematically illustrates the method and process of verification of job displacement 502 due to artificial intelligence, automation or robotics, where the computer implemented system of present invention electronically or manually using various methods, verifies the job displacement of claimant by the artificial intelligence, automation or robotics. The method of verification includes manual steps of On-site visits 504, Yearly Audits 506 by the personnel of a computer implemented system of present invention to verify the cause of job loss or verification of announced layoff or reorganization 508 of an organization of a claimant. The method of verification of job loss by the present invention further includes, verification of Robot tax identification number 510 which replaces the claimant; verification of robotic barcode identification number 512; softwares of the organization 514 or via manufacturers 516. Further, the method of verification by the present invention includes confirmation letter by the human resources department 518 of claimant; confirmation letter by direct manager of an organization 520 of claimant; Confirmation letter by the state unemployment 522 or by questionnaire/survey 524. Moreover, the method of verification by the present invention includes verification of witness statements 526; verification of company announcements and emails 528; verification by videos and recordings 530 and by verification through facetime 532. The computer implemented system of present invention also verifies the reason of job displacement by method of; verifying job displacement tracker databases 534; verifying job identification number 536; identifying employee identification number 538 and identifying job description 540. After steps of verification of reason of job displacement by any of the method, the computer implemented system then reviews the claim 542 and accordingly approves the claim 544.

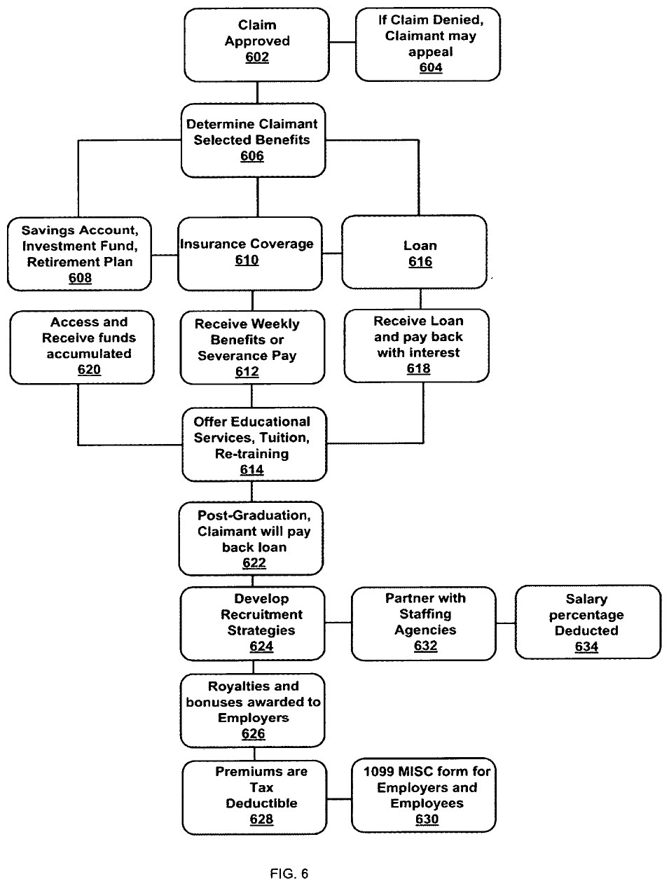

Referring to FIG. 6 which schematically illustrates the process by the system and method of providing insurance coverage and additional benefits after approval of claim 602 of claimant. In case the system finds fraud in claim by claimant, the system electronically rejects the claim and allows the claimant to appeal 604 further. After approval of the claim by the computer implemented system, the system electronically determines predefined benefits of the claimant 606; where benefits of the claimant can be any of saving accounts with regular disbursement of funds into the account, investment fund, retirement plan etc. 608; Insurance coverage 610 such as lump sum amount or weekly, monthly or yearly premium or severance pay 612; Loan 616 to the claimant or loan and payback with interest 618; and access accumulated funds 620. The present computer implemented system for providing insurance policy for the job displaced due to artificial intelligence, automation or robots, where the system, in addition to these benefits, further offers educational services, tuition or re-trainings 416 for the job displaced individuals to introduce new skill that may help them to get a new job. The present computer implemented system for providing insurance policy for the job displaced due to artificial intelligence, automation or robots, where the system further provides teaching of recruitment strategies 624 to aware individual about the recruitment process and strategies for getting recruit. Also, the system partners with the staffing agencies 632 that may help the individuals to easily get a new job based on their old and new skills. Moreover, the system also provides benefits of royalties and bonuses awarded to employers 626; tax deductible premiums 628; and 1099 MISC form for employers and employees.

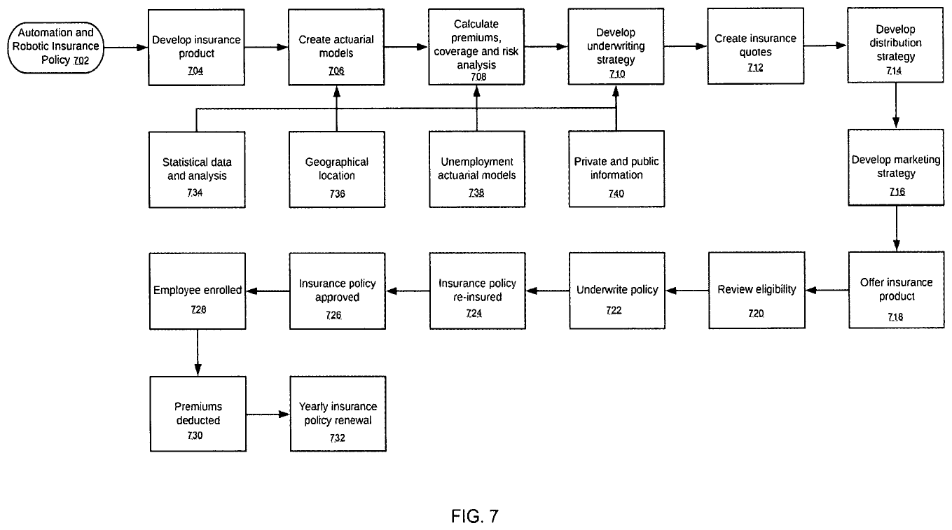

FIG. 7 schematically illustrates the method of development, offering and providing insurance policy 702 to the individuals by the computer implemented system of present invention. The computer implemented system and method for providing insurance policies to the displaced by the technology, where the system develops variable insurance products 704; creates an actuarial models 706 by using various statistical data and analysis 734, geographical locations 736, un-employment actuarial models 738, and private and public information 740; Calculates premiums, coverage and risk analysis 708; develops underwriting strategy 710; creates insurance quotes 712; electronically develops distribution strategies 714; develops marketing strategies 716; electronically offers insurance products 718; electronically receives application for registrations and reviews eligibility of applicant 720; electronically underwrites policy for the applicant 722; re-insures the insurance policy electronically 724; approves and provides insurance policy to an applicant 726; enrolls the individual/applicant into the system 728 and opens the Automation Job Displacement Savings Accounts (AJDISA) of the applicant; deducts premiums according to the policy 730; and allows applicant to renew the policy yearly 732.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

I claim:

1. A computer implemented system for providing variable insurance policy to an individuals who may be or has been displaced by an advancement in technology, the system comprising:
(i) a processor having a logic machine for electronically defining, offering, verifying and providing insurance policy and coverage to the individuals;
(ii) an storage machine communicatively coupled to the processor and comprising an algorithms or computer readable programs executable by the processor;
(iii) an input subsystem or a user interface device to allow the individuals to electronically access the computer implemented system, to register and purchase the insurance policy, to claim the insurance coverage and to receive the benefits and insurance coverage;
(iv) a display subsystem to display a graphical user interface or any visual element of the insurance policy;
(v) a communication subsystem to allows the computer implemented system to communicate with a plurality of the user interface devices of the individuals; and
(vi) a GPS subsystem to allow the computer implemented system to determine the location of plurality of the user interface devices of the individuals.

2. The computer implemented system of claim 1, wherein the displacement by advancement in technology includes displacement by any of the artificial intelligence, algorithms, augmented reality, automation, software, machine learning, technology or virtual reality.

3. The computer implemented system of claim 1, wherein the processor with logic machine is configured to:
a. electronically receive a request of registration and the individual's data from the user interface device of the individual for the job displacement insurance policy;
b. apply and execute the algorithms and programs over the individual's data to identify the risk and other factors or to determine qualification of the individual for the insurance policy;
c. electronically offer the job displacement insurance policy to the individual;
d. electronically establishes an Automation Job Displacement Insurance Savings Account (AJDISA) of the individual to submit premiums;
e. receive a request of benefit and an insurance coverage claim from the user interface device of the individual;
f. verify the reason and authenticity of the insurance coverage claim; and
g. disperse the insurance coverage into the Automation Job Displacement Insurance Savings Account (AJDISA) of the individual as per an agreement of the job displacement insurance policy.

4. The computer implemented system of claim 3, wherein the risk and other factors includes risk factors, rating factors, risk premium related assumption factor, expense related assumption, retention assumptions, competition analysis, profitability criterion, inflation rate, interest rate, risk discount rate and margins for adverse deviation.

5. The computer implemented system of claim 3, wherein the individual's data includes geo-location of the individual, demographics, government studies or federal data about the individual, personal or employer organization details, job history, actuarial and parameterized details and other required documentation.

6. The computer implemented system of claim 1, wherein the variable insurance policy for the job displaced individuals further comprises educational assistance including courses and tuitions for new skill development, recruitment strategies such as job seeking and job training assistance, and introduction with staffing agencies to help the individual in getting new job.

7. The computer implemented method for providing variable insurance policy to an individuals who may be or has been displaced by an advancement in technology, the method comprising steps of:
a. allowing the individual to register though the user interface into the computer implemented system;
b. electronically receiving and identifying the geo-locations, demographics, government studies or federal data about the individual, personal or employer organization details, job history, actuarial and parameterized details and other required documentation;
c. evaluating risk and other factors by the logic machine of the processor of the computer implemented system using received and identified individual data;
d. electronically offering insurance policy and underwriting insure based on risk assessment;
e. electronically establishing an Automation Job Displacement Insurance Savings Account (AJDISA) of the individual to submit premiums
f. electronically issuing the job displacement policy to the prospective individual;
g. allowing the individual to electronically claim the insurance coverage using the user interface in case of job displacement by the advancement of technology;
h. electronically reviewing and investigating the insurance claim by the processor of the system;
i. manually and electronically verification of the reason of the job loss;
j. acceptance or denial of insurance coverage by the computer implemented system based on authenticity of the insurance claim.

8. The computer implemented method of claim 7, wherein the displacement by advancement in technology includes displacement by any of the artificial intelligence, algorithms, augmented reality, automation, software, machine learning, technology or virtual reality.

9. The computer implemented method of claim 7, wherein the risk and other factors includes risk factors, rating factors, risk premium related assumption factor, expense related assumption, retention assumptions, competition analysis, profitability criterion, inflation rate, interest rate, risk discount rate and margins for adverse deviation.

10. The computer implemented method of claim 7, wherein the variable insurance policy for the job displaced individuals further comprises educational assistance including courses and tuition for new skill development, recruitment strategies such as job seeking and job training assistance, and introduction with staffing agencies to help the individual in getting new job.

11. The computer implemented method of claim 7, wherein the method of manually verification includes On-site visits, yearly audits, verification of Robot tax identification number which replaces a claimant; verification of robotic barcode identification number, confirmation letter by the human resources department of the claimant; confirmation letter by direct manager of an organization of the claimant; Confirmation letter by the state unemployment, and verification of witness statements.

12. The computer implemented method of claim 7, wherein the method of electronically verification includes verification of announced layoff or reorganization of an organization of the claimant, verification of company announcements and emails, verification by videos and recordings, verification through facetime verification of job displacement tracker databases, and verification of job identification number.
